(19) United States
(12) Patent Application Publication
(10) Pub. No.: US 2014/0127537 A1
(43) Pub. Date: May 8, 2014

(54) BATTERY CELL MODULE, METHOD FOR OPERATING A BATTERY CELL MODULE AND BATTERY AND MOTOR VEHICLE

(71) Applicants: Samsung SDI Co., Ltd., Yongin-si, Gyeonggi-do (KR); Robert Bosch GmbH, Stuttgart (DE)

(72) Inventors: Claus Gerald Pflueger, Markgroningen (DE); Ralf Angerbauer, Moglingen (DE); Holger Fink, Stuttgart (DE)

(73) Assignees: Samsung SDI Co., Ltd., Yongin-si, Gyeonggi-do (KR); Robert Bosch GmbH, Stuttgart (DE)

(21) Appl. No.: 14/127,348

(22) PCT Filed: Jun. 18, 2012
(86) PCT No.: PCT/EP2012/061586

§ 371 Date: Dec. 18, 2013

(30) Foreign Application Priority Data
Jul. 12, 2011 (DE) 10 2011 079 037.3

(51) Int. Cl. H01M 2/12

(52) U.S. Cl. CPC H01M 2/12
USPC 429/50; 429/53; 429/56

(57) ABSTRACT

A battery cell module includes a plurality of battery cells, which each have a ventilation opening. The battery cell module also includes a gas accommodation chamber which is assigned to a plurality of battery cells to at least temporarily accommodate gas which has escaped from said battery cells. The volume of the gas accommodation chamber is connected directly to the ventilation openings.

The present invention relates to a battery cell module that comprises a plurality of battery cells. In addition, the present invention relates to a method for operating a battery cell module in accordance with the invention, and also a battery that comprises several of the battery cell modules in accordance with the invention, and a motor vehicle.

The present invention relates in particular to lithium-ion battery cells or rather lithium ion batteries or corresponding battery cell modules.

### PRIOR ART

There is a considerably high demand for batteries for use in a wide range of applications for example for vehicles, stationary installations, for example wind power installations, and mobile electronic devices, for example laptops and communication devices. Extremely high demands are placed on these batteries with respect to reliability, serviceable life and efficiency.

Lithium ion technology is pre-destined for use in a wide range of applications. Said technology is characterized amongst other things by a high level of energy density and an extremely low level of self-discharge.

Lithium ion cells comprise at least one positive and one negative electrode (cathode or anode respectively) that by means of an electrolyte component can reversibly attract (intercalation) or repel (de-intercalation) lithium ions (Li⁺).

Intercalation is performed as the battery cell is being charged and de-intercalation is performed as the battery cell is being discharged in order to supply current to electrical units.

The presence of a so-called lithium ion conducting salt is required in order to perform the intercalation process and also the de-intercalation process. Lithium hexafluorophosphate (LiPF₆) is used as a lithium conducting salt both for battery cells that hold a comparatively small charge, for example for use in portable electronic devices, and also in battery cells for the automotive industry. This conducting salt is extremely reactive in response to moisture and as a result hydrolysis can occur up to the point that hydrogen fluoride (HF) is produced.

A critical point when using lithium ion technology is the behavior of the respective cell or rather the battery that is assembled from said cells in the case of overcharging. In the case of overcharging, the cathode can become damaged releasing powerful oxidizing agents. This can lead to a severe exothermic reaction in the electrolytes. Hot gases are produced and this increases the pressure in the battery cell interior.

This pressure can cause an uncontrollable temperature rise in the cell (so-called “thermal runaway”) and also causes a safety device of the cell, for example a so-called “safety vent” to open as a result of the pressure. If the cell does not open, there is a risk that the cell will explode.

A safety device in the form of a so-called “safety vent” is disclosed in US 2009/0068550 A1, which safety device opens a degassing orifice in the case of an inadmissible overpressure in a battery cell.

Degassing orifices of this type can be designed as predetermined breaking sites. The escaping gases contain an electrolyte and react with water to produce hydrofluoric acid. In order not to pose a danger for equipment and persons, it is necessary that the gas escaping from the battery cells is discharged in a controlled and purposeful manner.

Hazardous media are frequently captured and discharged by means of a so-called module cover that is arranged on the battery cell module.

DE 20 2004 004 335 U1 discloses in this connection a degassing system for accumulators, in which escaping gas must flow through a labyrinth in order to separate solids and liquids prior to the gas passing into a so-called gas outlet chamber in the cover. This design is encumbered with a relatively high structural outlay and consequently also a relatively high outlay with regard to manufacturing technology.

DE 102 57 918 B4 discloses an accumulator on which a so-called block cover is arranged, said block cover in turn comprising an upper cover and a lower cover. Gas chambers that correspond in each case to the number of battery cells are arranged in the block cover for the purpose of capturing the acid. As a result of the structural design, this embodiment of a gas receiving cover is also relatively complex and cost-intensive during the manufacture and assembly process in particular when producing large quantities.

### DISCLOSURE OF THE INVENTION

A battery module is proposed in accordance with the invention, which battery module comprises a plurality of battery cells that can be in particular lithium-ion battery cells. The battery cells each comprise a degassing orifice. Furthermore, the battery cell module comprises a gas receiving chamber that is allocated to several battery cells for the purpose of at least temporarily receiving gas that is escaping from these battery cells, wherein the volume of the gas receiving chamber is directly connected to the degassing orifices.

In other words, the gas receiving chamber is preferably allocated to all the battery cells of the battery cell module collectively and consequently is available to several battery cells simultaneously.

Consequently, the flow of gases exiting the degassing orifices is not deflected and this renders it possible to collect and discharge gas in a simple and cost-effective manner.

It is preferred that the volume of the gas receiving chamber is directly connected to the degassing orifices, in other words, without it being necessary for the gas to flow through inter-positioned chambers. If necessary, gas only flows through relatively short line connectors. As a consequence, it is possible as a flow is generated in the gas receiving chamber to efficiently generate a negative pressure at all the degassing orifices so that escaping gas can be discharged reliably and rapidly.

In accordance with the invention, the opening region of the gas receiving chamber can extend over several battery cells.

In this embodiment, the cover is preferably completely sealed with respect to the surfaces of the battery cells, in other words, at least fluid-tight and in the preferred embodiment completely gas-tight. The cover lies in a sealing manner against several battery cells, wherein the same opening region is arranged above several battery cells so that the gas that is escaping from these several battery cells can pass through the same opening region into the gas receiving chamber of the cover. The sealing arrangement is achieved by means of an expedient sealing element at the cover and/or at the battery cells, such as for example by means of a cellular rubber seal. The surfaces of the battery cells against which the cover is lying are preferably the respective cover surfaces of the battery cells from which the terminals protrude.

It is preferred that the battery cells lie one against the other or that intermediate layers are provided between the battery cells so that an essentially uninterrupted surface of the battery cell module is formed in the region of the battery cells against which the cover is lying in a sealing manner. In other words, there are no gaps between the battery cells that would otherwise be filled with a solid and sealable material so that it is possible to seal the gas receiving chamber that bridges several battery cells or rather to seal its opening region with respect to the battery cells. As a result of this embodiment in accordance with the invention, it is no longer necessary to arrange the battery cells of a module in an extra housing because by virtue of the design of an uninterrupted surface it is possible to seal the downwardly open gas receiving chamber. Due to the fact that in accordance with the invention it is no longer necessary for the battery cell module to comprise a housing, it is likewise possible to achieve advantages in relation to manufacturing technology and also to achieve a weight reduction.

The area covered by the opening region can correspond to the region of the projection of the gas receiving chamber onto the surfaces of the battery cells that are covered by the cover. The term ‘projection’ refers to a perpendicular projection of the gas receiving chamber onto the surfaces covered by the cover. In other words, the maximum width and length of the gas receiving chamber essentially defines the area of the opening of the gas receiving chamber in the direction of the battery cells. In other words, the maximum cross-sectional area of the gas receiving chamber is the area of the opening region. However, the invention is not limited to a design of this type but rather the battery cell module in accordance with the invention can also be formed in such a manner that the area of the battery cells that is covered by the opening region is smaller than the region of projection of the gas receiving chamber onto the surfaces that are sealed by the cover.

In a further alternative embodiment, the gas receiving chamber comprises several gas inlet orifices that are connected to a respective degassing orifice of a battery cell in such a manner as to allow a gas flow. In other words, in this embodiment a gas inlet orifice of the gas receiving chamber is coupled in each case to a degassing orifice of a battery cell. The length of the mechanical coupling site is preferably extremely short. The advantage of this embodiment resides in the small outlay required for sealing the gas receiving chamber with respect to the battery cells because the degassing orifices are fastened directly to the gas inlet orifices, namely preferably by means of short line connectors or rather lines that have a length L ratio with respect to the diameter D of L/D≦0.5.

As a consequence, any aggressive media that are exiting the battery cells can be discharged in a simple and cost-effective manner.

It is preferred that the cover is formed with one wall irrespective of whether it is embodied with only one large opening region or with several gas inlet orifices, wherein the gas receiving chamber is embodied in the cover by means of an embodiment which is substantially concave in regions. A cover of this type is in particular extremely simple to achieve as far as the manufacturing technology is concerned. The invention is not limited to the single-wall embodiment of the cover but rather the cover can also be embodied in such a manner that it is constructed from several layers.

The mentioned concave embodiment is understood to mean also a rectangular chamber boundary that comprises essentially a chamber design in the direction remote from the battery cells. This concave embodiment can be achieved by re-shaping a single-layer cover material or also by removing solid material from the cover material.

In the design variant embodiment that comprises several gas inlet orifices, it is advantageously provided that at least one multi-limb seal is arranged in the connecting region between a material that forms a respective degassing orifice and a material that forms a respective gas inlet orifice.

This seal can be for example a V-ring seal, in other words, a seal that comprises two limbs that are spread open in the non-loaded state and in the mounted and loaded state extend essentially parallel with one another, wherein at least one limb as a result of its elastic property improves by means of its restoring force a sealing effect with respect to a material that forms a respective degassing orifice or with respect to a material that forms a gas inlet orifice.

Gas pressure in the gas receiving chamber can urge the limbs away from one another and as a consequence the sealing effect is further enhanced.

In order to discharge the gas that is collected in the gas receiving chamber, it is provided in an advantageous embodiment that this gas receiving chamber comprises at least one outlet orifice. A connection device for connecting a line, such as for example a hose, can be provided at the outlet orifice in order to transport the escaping gas away from the battery cell module and to discharge said gas in a purposeful manner into the environment at a site where the gas does not pose a danger. The connection device can for example be in the form of a T-piece whose two pipe connectors are designed so as to connect in each case one hose, so that several connection devices can be series connected to one another in a simple manner, as a consequence of which the outlay for discharging the gases from several battery cells is reduced.

In the event of an overpressure occurring in a battery cell, the degassing orifice of said battery cell opens so that gas passes from the battery cell into the gas receiving chamber. This overpressure causes the gas that has been received in the gas receiving chamber to be transported away from the battery cell through the connection device.

A non-return valve can be connected to the outlet orifice, wherein this non-return valve is preferably a lip valve that is also known under the English term ‘duck bill valve’. This lip valve can be connected directly to the outlet orifice or to a line that is coupled to the outlet orifice. The lip valve renders it possible for gas to flow out of the gas receiving chamber and prevents a gas flow in the reverse direction.

In an advantageous embodiment, the lip valve comprises a predetermined breaking site that is designed in such a manner that in the event of a predetermined gas pressure being exceeded in the gas receiving chamber a tear occurs in said lip valve which allows an opening to be produced through which gas can flow out of the gas receiving chamber. The tear or rather the predetermined breaking site is preferably in the region in which the lips lie against one another or rather abut against one another. In the case of the lip faces being arranged in an acute-angled manner with respect to one another, an increase in pressure in the external environment causes the lip faces to be influenced by pressure from outside so that said lip faces are urged against one another and produce a sealing effect.

Also proposed in accordance with the invention is a method for operating a battery cell module having a lip valve, wherein in the event of the predetermined gas pressure being exceeded in the gas receiving chamber the opening is produced and in the event of a subsequent shortfall of the predetermined gas pressure in the gas receiving chamber the lip valve seals the gas receiving chamber with respect to the environment and/or essentially prevents gas from flowing out of the gas receiving chamber. Prior to the predetermined breaking site opening for the first time and in the event of a shortfall of the predetermined gas pressure in the gas receiving chamber, the lip valve prevents gas from flowing out of the gas receiving chamber through lips that are mutually connected in a gas-tight manner or rather through planar elements. However, if an inadmissible overpressure occurs in the gas receiving chamber, the connecting region between the lips or rather between the planar elements tears and the opening is revealed.

Gas is prevented from flowing out or rather the lip region is sufficiently sealed after being opened in the event of a shortfall of the predetermined pressure by virtue of the fact that the regions of the lips that can form the opening come into contact with one another. These regions can come into contact with one another as a result of the elastic forces of the lips or rather as a result of the elastic forces of their regions that can form the opening.

It is not possible to seal the gas receiving chamber with respect to the environment to the extent that would otherwise be ensured by virtue of the sealing effect of an unopened or rather non-torn lip valve, but nonetheless it is possible to achieve an essentially sufficient sealing effect.

In addition, a battery is provided in accordance with the invention, which battery is in particular a lithium ion battery and comprises several of the battery cell modules in accordance with the invention, wherein the battery cell modules are arranged in a collective housing and outlet orifices of the battery cell modules are flow-connected to a degassing line that is connected to a gas outlet in the collective housing. In other words, not every individual battery cell module comprises a housing but rather the battery cell modules are arranged in a collective housing that comprises all the battery cell modules. The respective outlet orifices that are connected to the gas receiving chambers of the battery cell modules are flow-connected to at least one degassing line through which the gas that is escaping from the battery cells can be transported until it can be discharged out of a gas outlet that is arranged in the collective housing into the environment in a purposeful and controlled manner.

In addition, a vehicle is provided in accordance with the invention, which vehicle is in particular a vehicle that is driven by an electric motor and comprises at least one battery cell module in accordance with the invention or a battery in accordance with the invention, wherein the battery cell module or rather the battery is connected to a drive system of the motor vehicle.

Gases that possibly arise in the battery cells or rather electrolyte are safely collected and discharged by virtue of the construction in accordance with the invention of the battery cell module and also of the battery. The battery cell module in accordance with the invention and also the battery can be produced in a simple manner using manufacturing and assembling technology and with increased safety and reliability to prevent assembling errors. Damage to and/or contamination of battery cells as gas is discharged from a battery cell is simultaneously prevented. This in turn provides increased protection against aggressive media for the repair or rather maintenance personnel which means that the battery cell module can be produced with less outlay and low costs.

### DRAWINGS

The invention is explained hereinunder with reference to the exemplary embodiments that are illustrated in the accompanying drawings, in which:

FIG. 1 illustrates a perspective view of a battery cell,

FIG. 2 illustrates a view of a cover from above,

FIG. 3 illustrates a view of a cover from below,

FIG. 4 illustrates a perspective view of a battery cell module in accordance with the invention,

FIG. 5 illustrates a view from the side of a battery cell module in accordance with the invention,

FIG. 6 illustrates a perspective view of a battery cell module in accordance with the invention in a further embodiment,

FIG. 7 illustrates a perspective view of the cover of the battery cell module illustrated in FIG. 6,

FIG. 8 is a schematic illustration of the cover of the battery cell module that is illustrated in FIG. 7 with a lip valve connected thereto, and

FIG. 9 is a sectional view of a region of the seal that is used between the battery cell module and the cover.

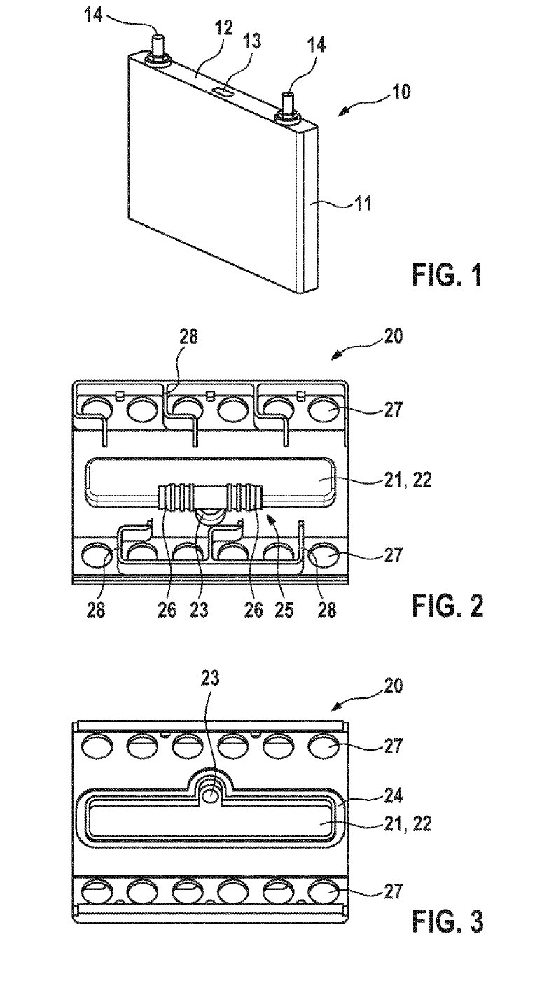

FIG. 1 illustrates the battery cell 10 that is used preferably in the battery cell module in accordance with the invention. This battery cell 10 comprises a battery cell housing 11 on whose upper face on which are also arranged the terminals 14 is arranged the face 12 that is covered by the gas receiving chamber 21. The degassing orifice 13 is also located in this face 12, which degassing orifice can be embodied for example as a predetermined breaking site or as an overload valve in order in the event of an inadmissible overpressure in the battery cell 10 to discharge gas from the battery cell housing 11.

FIGS. 2 and 3 illustrate an embodiment of the cover 20 of the battery cell module in accordance with the invention. It is evident that this cover 20 has an essentially rectangular shape, wherein the gas receiving chamber 21 that is embodied in this case as a concave curvature of the single-layer cover material is arranged in the central region. It evident in particular from FIG. 3 that the gas receiving chamber 21 is open in the downwards direction so that an opening region 22 is formed that has the contour of the gas receiving chamber 21. It is likewise clearly evident from FIG. 3 that an outlet orifice 23 is connected to the gas receiving chamber 21. A tubular connection device 25 is connected to this outlet orifice 23, as is evident from FIG. 2, and said tubular connection device is embodied as a T-piece. This connection device 25 comprises two pipe connectors 26 that are directed away from one another for the purpose of connecting additional connecting lines.

As illustrated in FIG. 3, a sealing element 24 that surrounds the edge of the opening region 22 is arranged in the cover 20.

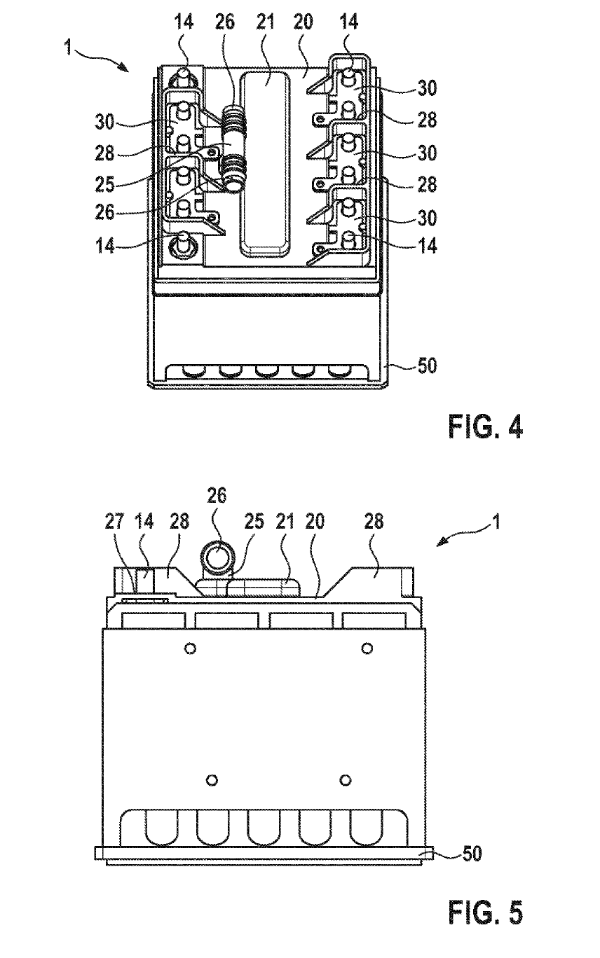

As is evident in FIG. 4, when the cover 20 is arranged over a plurality of battery cells 10 on the protruding terminals 14, the gas receiving chamber 21 and consequently also the opening region 22 overlies the battery cells 10 in a transverse manner so that the gas receiving chamber 21 and the opening region 22 extend essentially over the degassing orifices 13, illustrated in FIG. 1, of the battery cells 10. As the degassing orifice 13 is opened, gas passes through the opening region 22 into the gas receiving chamber 21. Gas is prevented from flowing outwards in the lateral direction by virtue of the sealing arrangement that is produced by means of the sealing element 24. The sealing effect that is produced by means of the sealing element 24 is improved by virtue of the fact that the surface of the battery cell module below the opening region 22 is planar.

The gas that is received into the gas receiving chamber 21 can pass through the outlet orifice 23 that is evident in FIG. 3 into the connection device 25 and into its pipe connector 26, so that gas can be transported away from the battery cell module 1 through lines, not illustrated, to this pipe connector 26. The volume flow of the gas is produced as a result of the relatively large overpressure of the escaping gas.

It is also evident in FIGS. 2 and 3 that the cover 20 comprises a plurality of holes 27 that are arranged on each side. The number of holes corresponds to the number of terminals 14 of the battery cells 10 that are to be connected using circuit technology.

It is evident from FIG. 4 that the terminals 14 protrude through the holes 27. Profile elements 28 in the form of so-called separating strips are arranged between the different holes 27 or rather terminals 14, which profile elements prevent the cell connectors 30 from connecting to the terminals 14 to which neither a structural connection nor an electrical connection is intended. In other words, by virtue of the arrangement of the profile elements 28, the cell connectors 30 only connect to one another those terminals 14 that are electrically contacted using circuit technology.

As a consequence, an assembly fitter is provided with a simple and efficient means for preventing assembly errors with respect to the positioning and the connection of the terminals and the electrical circuit of the battery cells by virtue of the fact that the profile elements render it impossible or at least difficult to form a connection between terminals that are not to contact one another. In other words, a so-called poka-yoke effect is achieved by virtue of designing the cover with profile elements. The number of holes in the cover preferably corresponds to the number of terminals of the battery cells of the battery cell module that are to contact one another.

FIG. 5 illustrates a view from the side of a battery cell module 1 in accordance with the invention, wherein the design of the pipe connector 26 for connecting a degassing line and also the concave curvature of the gas receiving chamber 21 are clearly visible. Furthermore, it is evident that the profile elements 28 are arranged higher than the terminals 14 as the cover 20 is placed on the battery cells 10, so that an erroneous connection of terminals 14 by means of the cell connector 30 is avoided.

It is preferred that the cover 20 is arranged between the cell connectors 30 and the housings of the battery cells. In other words, in this case the structure of the battery cell module 1 is achieved in such a manner that the cover 20 is arranged on the battery cells 10 or rather on their housings and in turn the cell connectors 30 are arranged on this cover 20, which cell connectors connect terminals 14 of the battery cells 1, which terminals protrude through holes 27 in the cover.

A battery cell module 1 in the latter mentioned embodiment is produced in such a manner that a cover 20 is placed in an essentially sealing manner on the side of several battery cells 10 that form a block placed on a base plate 50, on which side the terminals 14 of the battery cells 10 are located, so that terminals 14 of the battery cells 10 protrude through holes 27 in the cover 20 and subsequently the terminals 14 of the battery cells 10 are connected to cell connectors 30. The sides of the battery cells 10 on which the terminals 14 of the battery cells 10 are located are also the sides on which the degassing orifices 13 of the battery cells are located. In the case of the design of the battery cell module 1 with the profile elements, only those terminals 14 between which a profile element 28 has not been arranged are mutually connected by means of the cell connectors 30, as a consequence of which an erroneous connection of individual battery cells 10 is prevented.

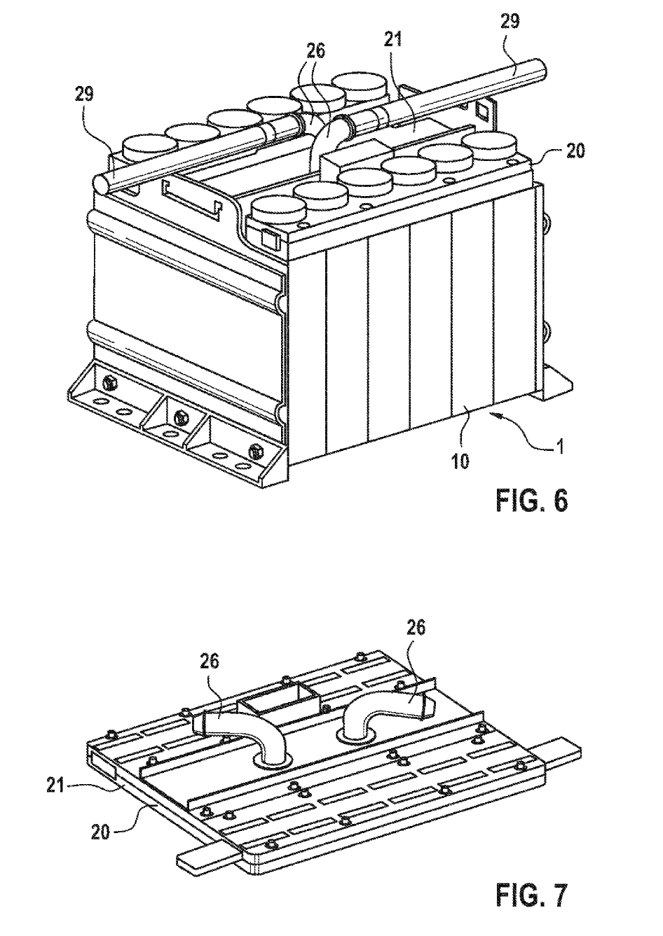

As is evident from FIG. 6, two pipe connectors 26 can be connected to the gas receiving chamber 21, which pipe connectors face opposite directions. Lines 29 in the form of hoses or pipes can be connected to these pipe connectors 26, which lines can likewise lead to outlet orifices in the housings. As a consequence, it is possible in a simple manner to connect several battery cell modules in accordance with the invention in a series connection that allows the flow of gas.

The cover that is used in FIG. 6 is illustrated in an enlarged view in FIG. 7. It is evident that the pipe connectors 26 that are embodied as elbows are preferably arranged in such a manner as to be able to pivot in order that the battery cell modules are flexibly interconnected in such a manner that allows the flow of gas.

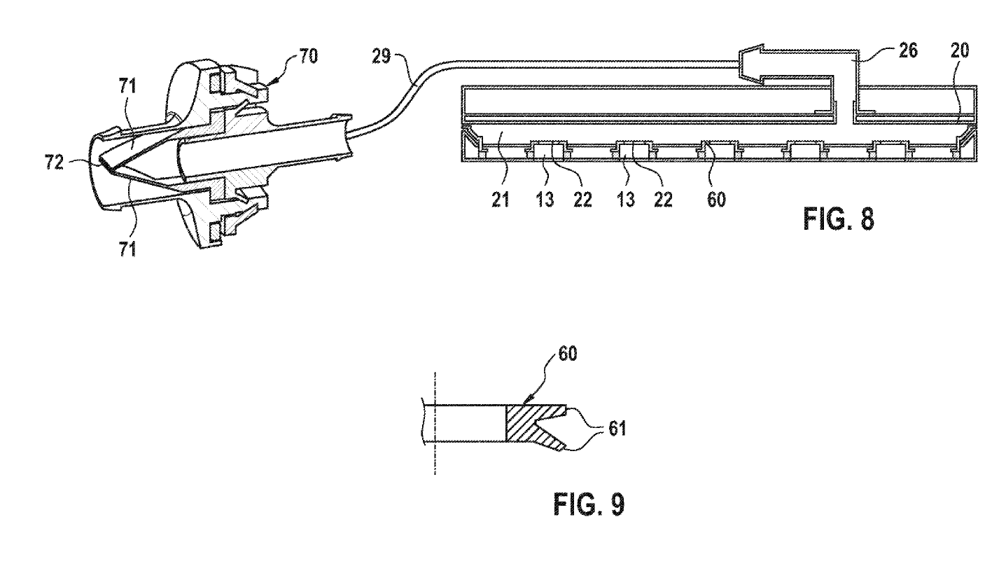

As illustrated in FIG. 8, the lines 29 that can be connected to the pipe connectors 26 are connected to non-return valves, for example to the lip valve 70 as is illustrated in FIG. 8. This lip valve 70 comprises two lips 71 that in the illustrated design variant are mutually connected in a linear region. This linear region is likewise the region where the tear occurs 72 if an inadmissible overpressure is present in the gas receiving chamber 21, which overpressure can cause a tear between the lips 71. As a result of the elastic properties of the lips 71, said lips once again lie against one another after a tear has occurred and as the pressure condition normalizes in the gas receiving chamber 21, so that it is possible to achieve an essentially sufficient sealing arrangement of the lip valve with respect to gases from the environment. In other words, a lip valve 70 is to be mounted preferably without an opening in the region where the tear occurs 72, and an opening in the region where the tear occurs 72 is only formed when an inadmissible overpressure is present in the gas receiving chamber 21 for the first time in order to allow gases to escape from the gas receiving chamber. If the pressure in the gas receiving chamber 21 drops back, the lips 71 of the lip valve 70 return to their closed position so that the gas receiving chamber 21 is essentially sealed with respect to the environment and as a result gases that are present in the gas receiving chamber and in one or several battery cells cannot ignite as a result of a fire that may occur in the environment of the lip valve and moisture cannot penetrate into a battery cell.

The cover 20 illustrated in FIG. 8 is preferably designed in such a manner that it comprises on its lower side in place of one opening region that covers a large surface area several gas inlet orifices 22 and in fact it is preferred that the number of degassing orifices 13 corresponds precisely to the number of battery cells that are assembled to form the battery cell module. In other words, it is preferred that each degassing orifice 13 is allocated a gas inlet orifice 22 in the cover 20. It is preferred that the sealing arrangement between the degassing orifices 13 and the gas inlet orifices 22 is achieved by means of a V-ring seal 60 illustrated in FIG. 9. At least one limb 61 of the V-ring seal 60 can in the unloaded state spread out from the plane of the seal, so that in the mounted and loaded state this braced limb 61 produces an increased pressing force and as a consequence an improved sealing effect with respect to the cover 20 or the material that forms a degassing orifice 13.

The present invention is not limited to the arrangement of the V-ring seal 60, illustrated in FIG. 9, or rather of the lip valve 70 on the design variant of the battery cell module in accordance with the invention that comprises in place of one opening region gas inlet orifices 22 but rather in a different manner thereto the invention can also provide that in the case of battery cell modules having an opening region in the cover 20 the cover 20 is sealed with the V-ring seal 60 and/or that a lip valve 70 is connected to the pipe connectors 26.

1. A battery cell module, comprising:
a plurality of battery cells each having a degassing orifice; and
a gas receiving chamber allocated to several battery cells of the plurality of battery cells, the gas receiving chamber configured to at least temporarily receive gases escaping from the several battery cells,
wherein a volume of the gas receiving chamber is directly connected to the degassing orifices of the several battery cells.

2. The battery cell module as claimed in claim 1, wherein the gas receiving chamber is open in a direction towards the several battery cells and an opening region of the gas receiving chamber is configured to extend over the several battery cells.

3. The battery cell module as claimed in claim 1, wherein:
the gas receiving chamber includes several gas inlet orifices, and
each gas inlet orifice is flow-connected to a respective degassing orifice of a respective battery cell.

4. The battery cell module as claimed in claim 3, further comprising at least one multi-limb seal arranged in a connecting region between a material that forms the respective degassing orifice and a material that forms a respective gas inlet orifice.

5. The battery cell module as claimed in claim 1, wherein the gas receiving chamber includes an outlet orifice configured to discharge the gases received into said gas receiving chamber.

6. The battery cell module as claimed in claim 5, further comprising a non-return valve connected to the outlet orifice, wherein the non-return valve is a lip valve.

7. The battery cell module as claimed in claim 6, wherein:
the lip valve includes a predetermined breaking site configured such that a tear occurs in said lip valve if a predetermined gas pressure is exceeded in the gas receiving chamber, and
the tear allows an opening to be produced through which gas can flow out of the gas receiving chamber.

8. A method for operating a battery cell module, comprising:
receiving gases that escape from battery cells in the battery cell module within a gas receiving chamber;
producing an opening through which the gases can flow when a predetermined gas pressure in the gas receiving chamber is exceeded, the opening produced in a lip valve which is connected to an outlet orifice of the gas receiving chamber, and
sealing the gas receiving chamber with the lip valve with respect to an environment when a subsequent shortfall of the predetermined gas pressure in the gas receiving chamber occurs.

9. A battery, comprising:
a collective housing;
a degassing line connected to a gas outlet in the collective housing; and
several battery cell modules, each battery cell module including:
a plurality of battery cells each having a degassing orifice; and
a gas receiving chamber allocated to several battery cells of the plurality of battery cells, the gas receiving chamber configured to at least temporarily receive gases escaping from the several battery cells,
wherein a volume of the gas receiving chamber is directly connected to the degassing orifices,
wherein the battery cell modules are arranged in the collective housing and the gas receiving chambers of the battery cell modules are flow-connected to the degassing line.

10. The battery as claimed in claim 9, wherein the battery is connected to a drive system of a motor vehicle.
